(19) United States
(12) Patent Application Publication
(10) Pub. No.: US 2012/0174075 A1
(43) Pub. Date: Jul. 5, 2012

(54) Automatically Testing a Web Application

(75) Inventors: Francesco M. Carteri, Roma (IT); Luca Lazzaro, Roma (IT); Flavio Pinzauti, Roma (IT); Alessandro Scotti, Roma (IT)

(73) Assignee: INTERNATIONAL BUSINESS MACHINES CORPORATION, Armonk, NY (US)

(21) Appl. No.: 13/395,302

(22) PCT Filed: Aug. 10, 2010
(86) PCT No.: PCT/EP2010/061577

§ 371 Date: Mar. 9, 2012

(51) Int. Cl. G06F 9/44

(52) U.S. Cl. 717/127

(57) ABSTRACT

A mechanism is provided for automatically testing a web application running inside a web browser. Pieces of test code are included in the web application code. An HTTP server provides a test service to the web application instrumented with test code. Through an API interface, the test code requests to the HTTP server that user inputs be simulated and sent to the browser. The HTTP server generates simulated system events corresponding to the user input and sends them to the browser. The browser processes the system events for the web application as usual. In this way the test code will check the data structure of the web application and the entire environment of the web application will be included as well.

### BACKGROUND

The present invention generally relates to development of software applications and more particularly to a mechanism for testing web applications.

A big issue of the web applications is to find out an effective approach for the test automation of the web interfaces. The problem is more relevant with web interfaces built with the new technologies of the web 2.0® (such as AJAX or JavaScript™ frameworks, e.g. Dojo®). A web page of the web 2.0® applications is not simply dynamic but is a very complex application that is the result of the composition of many object oriented language DOM elements (DOM is the Document Object Model that is a hardware and language independent model for representing HMTL pages and managing objects in HMTL). Each DOM element could be built dynamically through JavaScript (JavaScript™ is a trademark or registered trademark of Oracle Corporation or its subsidiaries in the United States and other countries) code interacting with a backend and implementing the AJAX® (asynchronous JavaScript™ and XML) technology to create client side web applications and even applying cascading style sheets to allow change the appearance from the client side. Also, the code for creating the DOM elements is scattered in many points and could also be generated by widgets (created with AJAX® frameworks) written separately to implement a single functionality.

The main problem is not only to implement a system for a unit test suite to test the single functionalities, the single widget classes, but also to test the real interaction among DOM elements generated by the widgets and the other parties producing the DOM elements.

Tools of prior art for testing web applications based only on the “external” appearance of a web page or application, or even if they are aware of the DOM elements, will completely miss the internal of the application. Conversely, the application has no way to force a test of this important area, because it has no means to access and drive the “outside” behavior of itself, such software having strong dependencies on the hosting environment (e.g. these applications run in the browser). Automatically testing such web applications is a challenge.

The U.S. patent application U.S.2004/0025083A1 describes the general idea of embedding test code into a program, so that the program can test its functionality. However, despite the broad scope of the invention, it is not possible to use that method to solve the problem of fully testing the internal of the applications in the context of the browser and the operating system hosting it. Some code portions of the applications that depend on differences in the environment cannot be tested; furthermore, some code portions of the applications that depend not only on such differences but also on the different code paths that such differences may lead to execute will not be tested as well. For example, a web application must be separately tested on each of the supported browsers, e.g. Internet Explorer® (Internet Explorer® is a trademark of Microsoft Corporation in the United States, other countries, or both), Firefox® (Firefox® is a registered trademark of the Mozilla Foundation), Opera™ (Opera™ is either trademark or registered trademark of Opera Software ASA), etc. However, for testing purpose, it is not reliable having a test code that ignores the differences that each browser may introduce and only takes into account direct calls to the software functions.

There is a need for a method of instrumenting web interface code with code simulating a user input in a page of the web interface for testing the internal of the application in the context of the browser and the operating system hosting it.

### SUMMARY

It is therefore an object of the present invention to have an automatic testing mechanism simulating a user input in a page of the web interface and validating the web interface internal data structures of the web application in the context of the browser and the operating system hosting it.

The object is achieved, according to one illustrative embodiment, with method for automatically testing a web application running inside a web browser of a testing computer, the web application being instrumented with test code. The method comprises sending from the test code executing in the web application, through an API defined in the web application, a message to a server asking the server to simulate a user input, the user input being in relation with the test code running in the web application. The method further comprises the server receiving the message, simulating the user input by at least one system event according to the message and providing it to the web browser. The method further comprises the web browser processing (430) the simulated at least one system event which itself triggers execution of some code in the web application. The method further comprises the test code in the web application checking validity of result of triggering of some code in the web application by the at least one system event, by inspecting the web application internal data structure. The internal data structure of a web application comprises the elements that are visible from web pages and internal counters or other possible variables and objects.

### BRIEF DESCRIPTION OF THE SEVERAL VIEWS OF THE DRAWINGS

FIG. 1 illustrates a context of a web application in which the solution of the illustrative embodiments can be implemented;

FIG. 2 illustrates an implementation in a context of a web application in accordance with an illustrative embodiment;

FIG. 3 is an illustration of a web application environment crossed by a simulated event according to an illustrative embodiment; and

FIG. 4 is the general flowchart of automatically testing a web application according to an illustrative embodiment.

### DETAILED DESCRIPTION

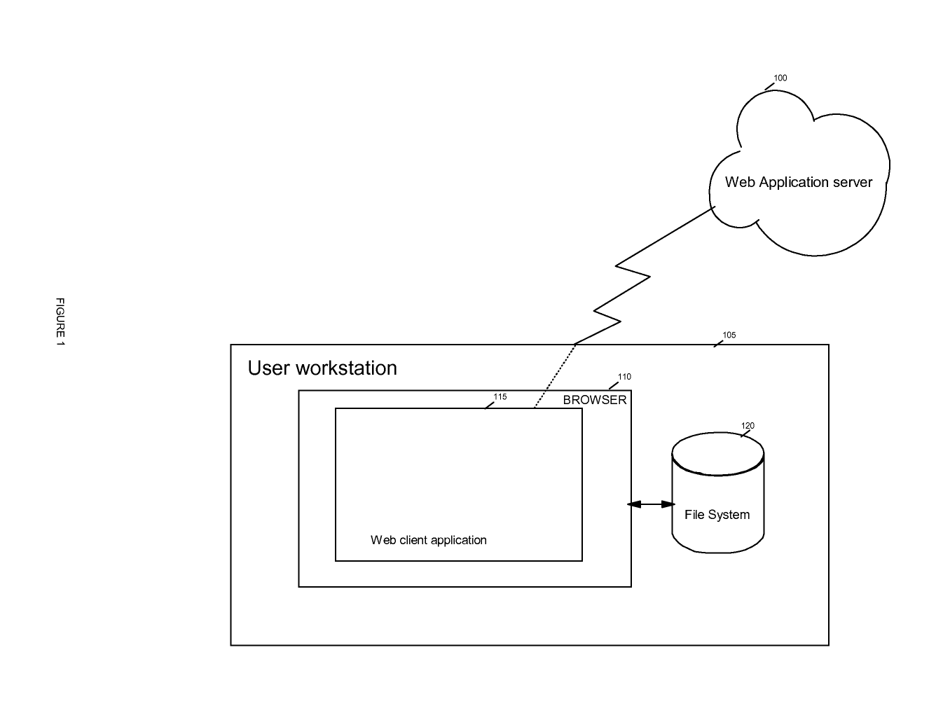

FIG. 1 illustrates a context of a web application in which the solution of the illustrative embodiments can be implemented. The context of a web application comprises a web client application (115) running in the browser (110) of the user workstation (105). The browser uses the file system (120) of the operating system of the user's workstation. The web client application has been downloaded from a web application server (100) through the network if the web application server is remote. The web application may be written in Javascript™ scripting language. The user interfaces the application through the web pages generated by the browser. The user inputs may be data entered in the web page fields generating system events (from keyboard or mouse for instance).

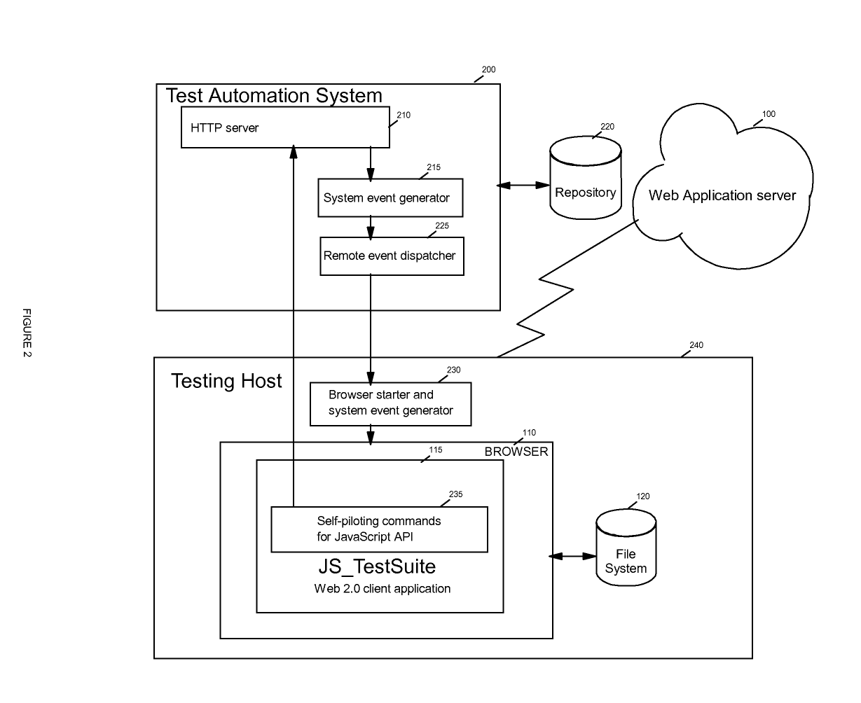

FIG. 2 illustrates an implementation in a context of a web application in accordance with an illustrative embodiment. A test suite written in a language understandable by the browser, JavaScript™ scripting language for instance, as the web application (115) which runs on a Testing Host (240). A web test Automation System (200) offers a test service to the web application (115) running on the Testing Host. The test service contains three subsystems which are a hypertext transfer protocol (HTTP) Server (210) that receives commands, the System Event Generator (215) that generates specified system events and the Remote Event Dispatcher (225) which dispatches the events to the host where the test suite runs when the test computer is remote. These subsystems may be implemented as software programs. A Repository (220) is used by the subsystems of the test service to load/save serialized objects representing the status of the application or other data (Javascript™ Object Notation (JSON) could be an example of linearized object encoding stored in the Repository).

In the web application running in the Testing Host, the JavaScript™ application programming interfaces (APIs) enable the Self-Piloting of the JavaScrip™ test code. The Self-piloting commands for Javascript™ API (235) allow the communication between the Javascript™ code from the browser (the web application) and the test service. A Browser starter (230) is optional and is for launching the browser on the URL of the Testing Host. When used, the browser starter receives the event from the Remote Event Dispatcher (225) which has itself received the event from the System Event Generator (215), and transmits the event to the browser. When there is no browser launcher, the browser is able to receive directly the simulated system events because the browser is started before the test code in the web application is executing. The browser (110) receives and processes the same event on the Testing Host. Inside the web application, the Test Suite code (web pages containing html/JavaScript™/Dojo® code) contains the code to test the objects and uses the Self-piloting commands for Javascript™ API (235) to check verification points and to trigger actions towards the HTTP Server (210) providing the test service.

It is noted that the entire Test System comprising the components of the Test Automation System and the Testing server could reside on a single computer. In this case where the Test Automation System and the Testing server reside on a single computer, there is no need to have the Remote event Dispatcher (225) and the Repository is local to the web application.

The JavaScript™ API establishes a communication with the HTTP server to allow the web application to send the event commands. The Service gets the commands and through the System Event Generator generates keyboard or mouse events that the browser (that runs always as on top window) catches, the events and the web pages changes occurring as if they were created by the user himself At this point the test automation code continues executing itself inside the web application.

Example of Verification points based on web page object checking, for instance DOM checks:

Assuming that the web interface provides a button, when the user clicks on the button, a new panel is displayed. In this example, the JavaScript™ code of the test automation should be the following: the JavaScript™ code requests a click of the mouse on the element of the button above. Then, the service receives the command through the JavaScript™ API and produces the related system events. Once the event is received, a new container structure (<DIV>) is generated in the DOM to contain the new panel (a sub DOM). The JavaScript™ code can then check if the DOM element has been inserted as expected.

Example Verification points based on object status checks:

Another way to implement the verification points is to save the objects (linearized for example as JSON strings) before to request simulated system events, then once the simulated system events are received, and the changes have been applied on the DOM, the JSON objects saved before can be loaded and compared to the changed objects. Assuming the web application includes in a web page a widget that changes the background-color when the mouse is over it. Suppose having on the master repository the widget object serialized as master value (with the background color expected with the color when the mouse is over the widget). In this case, the JavaScript™ test consists of requesting a JavaScript™ command event “mouse over” the widget then, when the events arrives to the browser and the mouse is moved over the widget automatically, the JavaScript™ test requests to the Service to compare the actual widget status width the one persisted into the repository. Each of these test suites generates the following actions: makes HTTP requests on dynamic web pages, save JSON objects as current status, generates event commands, (the Browser) catches the event and the web page changes, verify DOM changes comparing results with master values (templates), compare JSON objects with master values. Each test suite generates any kind of interactions between the Browser and the system.

The following exemplary tests can be implemented:

“Look Ahead,” (generating the events to type the first chars of a string to search).

“Field Validation” (generating the all keyboard chars).

“Save pages” (generating the event to access to the browser menu and save the page).

“File Upload” (generating the events to type and open a file on a browse popup).

“Localization” (generating the event to access to the browser menu and change the browser language).

“Browser-dependent,” generating the same keyboard and mouse events to test the different behavior of the events on the different browsers.

“Accessibility test cases,” using the sequences of (tab, enter) keyboard events.

Self-Piloting commands for JavaScript™ API are asynchronously sent to the HTTP server on a port, for example:

http://Servicehostname:port/?receiverhost=hostname&command=<name>&arg1=value1& . . . . . . &argN=valueN

Some of the base API commands may be as follows:

click(x,y)

doubleclick(x,y)

key(k) 'special keys are (tab, enter, left, right, up, down)

pause(delay)

fileload(filename)

filesave(filename)

Some API commands for the verification points based on the JSON comparing may be as follows:

saveAsJSON (object, name), saves the object as JSON string.

object loadJSON (name), converts the JSON string into an object.

checkJSON (object, object), compares two JSON objects.

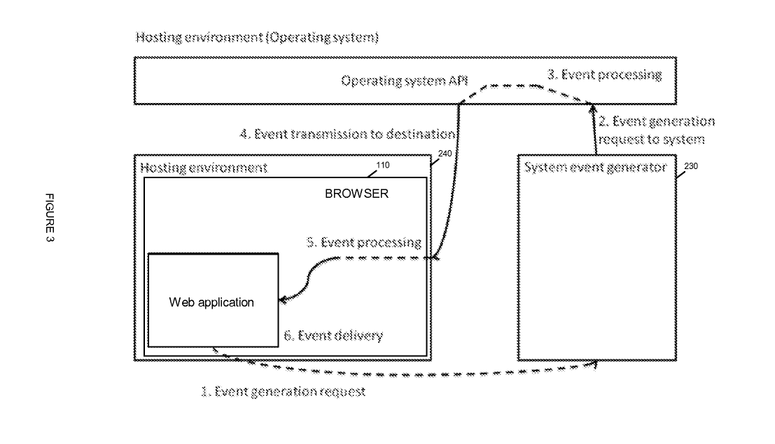

FIG. 3 is an illustration of a web application environment crossed by a simulated event according to an illustrative embodiment. The study of the events processing allows understanding difference with testing method of the prior art which only proposes to embed code into a program. The web 2.0 applications live in a container (e.g. web browser) that provides support for critical components (e.g. HTML rendering, DOM representation of documents, JavaScript™ language interpreter and function library, HTTP and HTTPS network communication, etc.) as well as a mechanism for receiving events from the system (e.g. in response to a user action or input). The implementation and behavior of such container and all related components is critical to web 2.0 applications: a web 2.0 application cannot be fully tested if this complex environment is not considered during the test.

Beginning in FIG. 3 at step number 1 (Event generation request) and step number 2 (Event generation request to system), this is basically the same starting point for user actions as well. As shown in the figure, the event travels quite a bit and is processed by several components and layers of code before being dispatched to the web 2.0 application. In doing so, it usually “leaves a track” in such layers of code and components, e.g. by modifying their data structures and so on. When the event is finally dispatched and processed by the web application, the application can respond to the event as if it had been triggered “for real” in a real-world situation. That is, the web application will find that its environment has processed the event as well and had a chance to react to it. This is not possible if the application simulates receiving the event all on its own, ignoring all of this long processing.

In the case where the web application is only able to test its response to a kind of “abstract” event, one that is unknown and does not affect the environment and the web application container, a full code coverage is not possible in this case. On the contrary, and this is particularly the case for web applications, every container (e.g. web browser) is different from any other, and often even from other versions of itself. Because of this, it is necessary to test the web application in every supported environment and again this is certainly not possible if the environment is fully integrated into the test scenario.

FIG. 3 is an example of how an event could be generated and dispatched to the software application. While the event is being processed there are steps that affect the hosting environment (step 3, Event processing to simulate the event, step 4, Event transmission to destination, and 5, Event processing reproducing the event by the browser in the picture) that cannot be reproduced by embedded code alone.

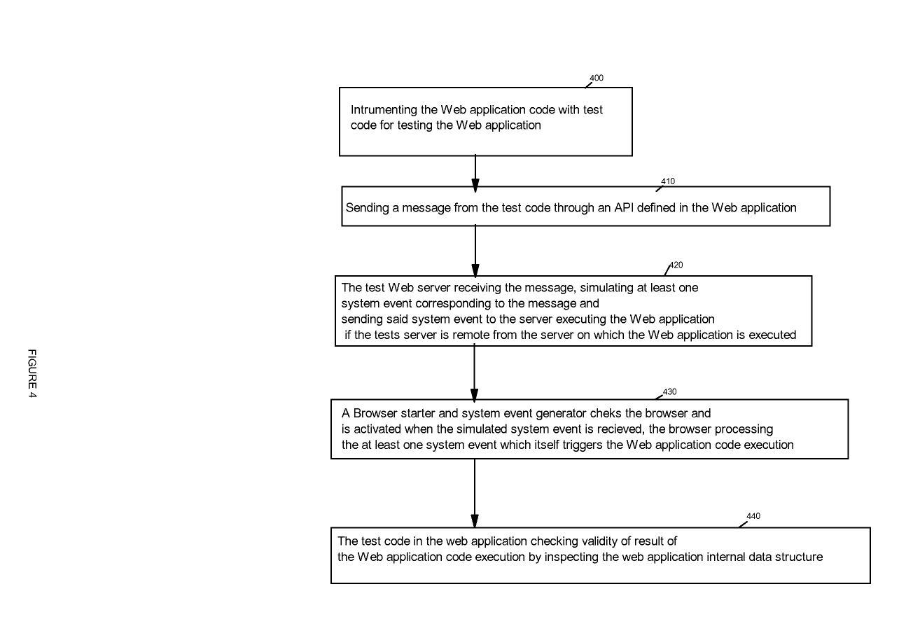

FIG. 4 is the general flowchart of automatically testing a web application according to an illustrative embodiment. The method is implemented on one host or two hosts but on two servers. One server runs the web application in its environment (web browser) and one test server interfacing the web application operates the test. The method for automatically testing the web application comprises a first step (400) of implementing test code inside web application code for testing the web application. A second step (410) is executed by a piece of test code sending to the test server and through an API a message including a command. In a third step (420) the test server receives the message and interprets the command to simulate a user input in a page of the web application or to generate a system event to be understandable also by the environment of the web application and by the web application. The user input or system event is in relation with the test code running in the web application. The test server sends the simulated user input or system event to the web browser including the web application. The web browser (430) processes the user input or system event which triggers the web application execution which is tested. The test code in the web application checks (440) the validity of the result of the web application code execution by inspecting the web application internal data structures either programmatically or by comparing their representation to a known template.

Some specific steps of the method are related to the example of verification points based on HTML object checks. For instance, assuming the mouse clicking of the user in a web panel, which is a part of a web page, generates a new web panel to be displayed by the application, step 410 will consist in requiring mouse clicking simulation, and step 430 will further include the web application in its normal code execution (not included test code execution) generates a new container structure corresponding to one HTML object (DOM object) instantiation corresponding to the new web page to be displayed. Step 440 will include test code checking that the object corresponding to this new web page has been well instantiated in the web application.

Other specific steps of the method are related to the example of verification points based on object status checks. For instance, checking that the use of a widget by the user has changed the color of the background of an HTML page. A request from the test code of the web application (410) could consist in asking that the initial status of the widget object be saved (for instance a widget to be saved as JSON string in the Repository) and asking through a JavaScript™ command to simulate a system event, such as a mouse move over a widget in the web page displayed to the user and containing this widget. Then, at reception of the simulated system event, when the browser executes the simulated mouse move, the web application executes the corresponding function and the test code (440) capturing the web page changes, sending a new request to the test service (410) to retrieve the saved object (JSON string) from the Repository, receiving the saved object through the web application API, and the test code reading the current widget status and verifying DOM changes, comparing JSON objects with saved object in the Repository. Each test suite generates any kind of interactions between the Browser and the system.

In summary, the mechanism for automatically testing the web application is complete as it tests both the internal structures (440) of the web application and the outside context (430) of the web application.

One example illustrating testing of the internal structure is to assume that the web application keeps an internal counter that keeps track of the number of widgets in error so that if the number is greater than zero then the whole panel is invalid and cannot be processed. A test that checks a correct response of the web application to an invalid input from the user could include three tests:

1) that the corresponding widget changes background color in order to show the error;

2) that a message appears to inform the user; and

3) that the internal counter is incremented by one unit.

Point 3) refers to an internal data structure of the application. The internal counter exists only in the web application, it cannot be tested by testing the external inputs as no HTML element or external representation corresponds to this counter. The code can analyze itself. An HTML, DOM, or JavaScript™ object has a data structure which is external as visible through the web interface of the web application and internal when it comprises data internal to the web application as the counter above.

One example illustrating testing of the outside context of the web application: assuming something happens out of the web application, in the operating system of the computer hosting the web application. The testing mechanism can test how the application reacts responding to the system events. Different behavior occurs for changing the browser or for changing the operating system in the host on which the web application is executed. Consequently, while the internal structure can be tested in response to an external event, as in the embedded test code of the prior art methods, the internal structure of the application can be tested only in response to an internal input simulated by the test code itself not by the system context.

The mechanisms of the illustrative embodiments allow testing data structures of the application by inspection of the data structure after a simulated user input. The mechanisms allow also to check application internal data structures by comparing object status after a simulated user input has occurred with an model object status which has been saved.

The objects may be HTML, DOM or JavaScript™ objects. An automatic testing system will comprise the HTTP server and the code to generate simulated system events corresponding to the tested system inputs.

To fully test a web application, the mechanisms of the illustrative embodiments not only comprise writing some test code and embedding it into the application but also give web applications access to the “outside” environment, including the ability of reproducing the real interaction of the user with a web interface. This method allows to simulate external inputs so that it is possible to receive it as if it comes from a human user or some external event source. In this way, the hosting environment will be able to also process the event and update its own data structure that also have a direct influence on the application behavior. Without this system in place, no test will be able to cover the entire software functionality.

The web application has the ability to interact with itself from the “outside” by means of an external service. The service controls the browser and the external systems (disk, etc.) and provides services to the web application by means of an HTTP connection with specially encoded URL's. In turn the web application uses the provided services to manipulate and control its internal state from the “outside”, which is not normally possible with current test automation systems.

The following method and system overcomes the limitations of the current test methodologies by reproducing and simulating the human user input and use the simulation to validate its internal data structures and algorithms. The method invokes the system events generated by a user input from the JavaScript code inside the web pages itself and produces changes on the web interface (thus on the object model elements DOM elements for instance). Once the changes are reflected on the DOM elements (by the user event requests) the JavaScript code can check the status of the internal data structures comparing with the expected values.

The mechanism of the illustrative embodiment provides several advantages. The mechanism can test anything of DOM elements reproducing the customer scenario by testing all the DOM elements in the application web pages. The solution allows covering the interesting test cases on the advanced examples sections above which cannot be covered by other type of products. A web page can be tested inside and outside of the page itself. The way to check the verification points based on the DOM checks and/or through JSON (for JavaScript™ Object Notation, is a simple format for representing objects with strings) objects comparing. The solution does not only apply to the DOJO® framework but can be leveraged on all technologies used for generating the DOM elements of the web pages. The mechanism can be implemented while the language used for the test suite and the application is different from JavaScript™ scripting language. The language needs only to be understandable by the browser.

With respect to the prior art automatic testing products and methodologies, in particular for web applications, the current state of the art provides a lot of features but ultimately the test result is obtained by comparing the “output” of the application to some template that is known to be correct. For a web application, output is basically the HTML page it produces or changes, or equivalently, the DOM representation of it. With the mechanisms of the illustrative embodiments, the web application can access the “outside” environment and simulate real behavior (including human input) that would not be possible by simple code instrumentation. The ability to inspect internal structures are missed by tools that can only inspect the program “appearance.”

1. A method for automatically testing a web application running inside a web browser of a testing computer, the web application being instrumented with test code, said method comprising:
sending from the test code under execution in the web application, through an interface defined in the web application, a message to a web server asking the web server to simulate a user input, the user input being relating to the test code running in the web application;
the web server receiving the message and triggering a system event generator to simulate at least one system event corresponding to the user input and providing the at least one system event to the web browser;
the web browser processing the simulated at least one system event to trigger execution of code in the web application; and
the test code in the web application checking validity of the result of the triggering of execution of code in the web application by the at least one system event, by inspecting the web application internal data structure.

2. The method of claim 1 wherein checking test code comprises checking that the web application correctly generates an internal data structure corresponding to a web page modification to be displayed by the web application.

3. The method of claim 2 wherein the at least one simulated system event is a mouse click requiring the web page modification.

4. The method of claim 1 wherein sending the message to the web server comprises the test code saving the initial status of an internal or external object data structure in a web page, requiring in the message the web server to store the initial status of the internal or external object data structure in a repository and to simulate at least one system event in relation with the object in the web page; an wherein checking validity of the result comprises checking that the web application has changed the external or internal object data structure in the web page, capturing the object data structure after the web page change, requiring in a new message through the interface defined in the web application the test server to retrieve the initial status of the object from the repository, receiving the retrieved initial object status, and verifying the change is correct by comparing the initial and the changed internal data structure.

5. The method of claim 4 wherein the at least one simulated system event is a mouse move in a web page over a widget.

6. The method of claim 1 wherein the external or internal object data structure comprises hypertext markup language, document object model, or object oriented scripting language objects.

7. The method of claim 6 wherein, the object is stored and retrieved by the web server as a script object notation string in the repository when the object is an object oriented scripting language object.

8. The method of claim 1 wherein sending the message to the web server comprises dispatching the at least one system event from the web server to the server on which the web application is executed in the case where the web server is remote.

9. The method of claim 1 further comprising coding the test and the web application in a language understandable by the browser.

10. The method of claim 1 further comprising coding the test and the web application in an object oriented scripting language.

11. The method of claim 1 wherein sending step the message to the web server and checking test code further comprise triggering manually the test code inside the web application through a piloting application.

12. The method of claim 1 wherein sending the message to the web server and checking test code are automatically executed by execution of the web application once started.

13. A system comprising:
a test automation system; and
instructions, wherein the instructions, when executed by the test automation system, cause the test automation system to:
send from the test code under execution in the web application, through an interface defined in the web application, a message to a web server asking the web server to simulate a user input, user input relating to the test code running in the web application; and
receive, by the web server, the message and triggering a system event generator to simulate at least one system event corresponding to the user input and providing the at least one system event to the web browser,
wherein the web browser processes the simulated at least one system event to trigger execution of code in the web application d the test code in the web application checks validity of the result of the triggering of execution of code in the web application by the at least one system event, by inspecting the web application internal data structure.

14. The system of claim 13 wherein checking test code comprises checking that the web application correctly generates an internal data structure corresponding to a web page modification to be displayed by the web application.

15. The system of claim 14 wherein the at least one simulated system event is a mouse click requiring the web page modification.

16. The system of claim 13 wherein the message to the web server comprises the test code saving the initial status of an internal or external object data structure in a web page, requiring in the message the web server to store the initial status of the internal or external object data structure in a repository and to simulate at least one system event in relation with the object in the web page; and wherein checking validity of the result comprises checking that the web application has changed the external or internal object data structure in the web page, capturing the object data structure after the web page change, requiring in a new message through the interface defined in the web application the test server to retrieve the initial status of the object from the repository, receiving the retrieved initial object status, and verifying the change is correct by comparing the initial and the changed internal data structure.

17. The system of claim 16 wherein the at least one simulated system event is a mouse move in a web page over a widget.

18. The system of claim 13 wherein the external or internal object data structure comprises hypertext markup language, document object model, or object oriented scripting language objects.

19. The system of claim 18 wherein the object is stored and retrieved by the web server as a script object notation string in the repository when the object is an object oriented scripting language object.

20. The system of claim 13 wherein sending the message to the web server comprises dispatching the at least one system event from the web server to the server on which the web application is executed in the case where the web server is remote.
